(19) United States
(12) Patent Application Publication
(10) Pub. No.: US 2004/0182971 A1
(43) Pub. Date: Sep. 23, 2004

(54) Fiber optic connector bracket

(76) Inventor: Manish Sharma, Cupertino, CA (US)

Correspondence Address: R. Burns Israelsen, WORKMAN NYDEGGER, 1000 Eagle Gate Tower, 60 East South Temple, Salt Lake City, UT, 84111, US

(21) Appl. No.: 10/797,158

(22) Filed: Mar. 10, 2004

Related U.S. Application Data
(60) Provisional application No. 60/455,538, filed on Mar. 18, 2003.

(51) Int. Cl. F16L 3/00

(52) U.S. Cl. 248/49

(57) ABSTRACT

A fiber optic mounting system is provided having a bracket which can be coupled to a base. The bracket includes a propping member and a connector member. The propping member includes a plurality of apertures configured to receive a plurality of coupling members. The coupling members can be couplings, connectors, and the like. The coupling members are configured to receive one or more ends of fiber optic cables to them from becoming entangled and/or damaged.

### CROSS-REFERENCE TO RELATED APPLICATIONS

This application claims priority from and benefit to U.S. Provisional Patent Application Ser. No. 60/455,538, filed Mar. 18, 2003 and entitled “Fiber Optic Connector Bracket,” which application is incorporated herein by reference in its entirety.

### BACKGROUND OF THE INVENTION

1. The Field of the Invention

This invention relates generally to fiber optic cables. More particularly, the present invention is directed to a fiber optic connector bracket.

2. The Relevant Technology

Fiber optic technology is becoming an increasingly popular means for providing high-speed, high-density data transmissions. For example, the telecommunications industry frequently uses fiber optics to transmit audio, visual, and other informational signals. As such, fiber optic networks are being developed at a rapid pace to meet the demanding need to provide world-wide fiber optic connections.

However, fiber optic components require additional considerations that traditional metallic wiring does not require. For example, fiber optic components can be more complex because of the need to align the fiber optic cable with the optical transmitting or receiving components. In addition, fiber optic cables can be fragile and thus require special handling. When multiple fiber optic cables are present, the operator usually lays the cables on the ground when not in use, subjecting the cables and fragile connector components to entanglement and breakage.

### BRIEF SUMMARY OF THE INVENTION

The present invention is directed to systems for organizing fiber optic cables. This may be advantageous during development or assembly situations where multiple fiber optic cables are being handled. A fiber optic mounting system is provided for keeping fiber optic cables organized and away from potential breakage. The fiber optic mounting system includes a bracket having a propping member and a connector member connected to the propping member. The connector member may form means for connecting the bracket to a base along with other connecting structures such as apertures formed in the connector member and screw bolts.

The propping member includes a plurality of mounting apertures which are configured to receive a plurality of coupling members. Each coupling member is configured to receive one or more segments of fiber optic cable. For example, if the coupling member is a coupler, it can receive a segment of fiber optic cable on each side. If the coupling member is a connector, it generally receives a fiber optic cable on one side.

The propping member and connecting member may be plates disposed at an angle to each other. In one embodiment, the plates are disposed at a 90 degree angle.

The bracket may reduce the possibly of breakage when handling multiple fiber optic cables in a production, laboratory or other setting. The bracket also provides a low cost solution for handling fiber optic cables. In addition, the bracket assists an operator or technician in organizing a plurality of fiber optic cables.

These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a perspective view of a fiber optic mounting system including a bracket; and

FIG. 2 illustrates an exploded perspective view of the bracket of FIG. 1.

### DETAILED DESCRIPTION OF THE PREFERRED EMBODIMENTS

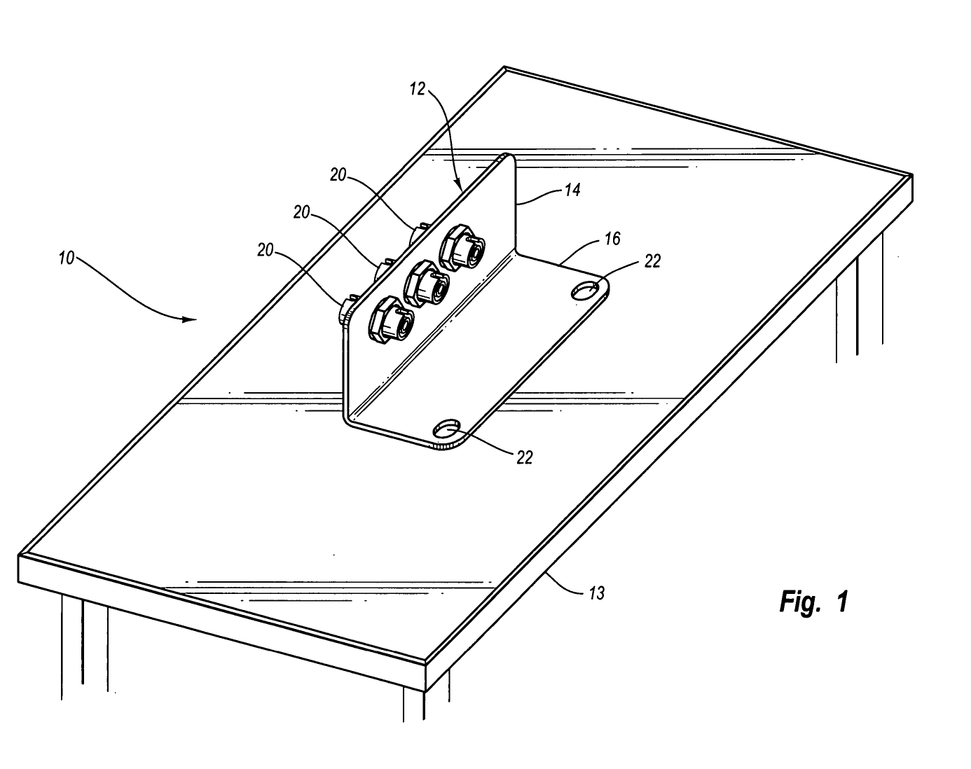

As shown in FIG. 1, a fiber optic mounting system 10 for handling fiber optic cables includes a bracket 12 coupled to a base 13 such as a table. The bracket 12 includes a propping member 14 and a connector member 16.

The propping member 14 is disposed so that it is easily accessible to an operator or technician. Propping member 14 is configured to hold a plurality of coupling members 20. In one embodiment, the propping member 14 can be in the form of a plate having one or more apertures 18 sized for receiving coupling members 20. As used herein, the term “coupling member” is used broadly to refer to a device which allows for a fiber optic cable to be joined thereto. In fiber optic technology, a “coupling” and “connector” refer to different types of coupling members. Thus, the term “coupling member” is used herein to broadly refer to the various types of ways a fiber optic cable can be connected to propping member 14.

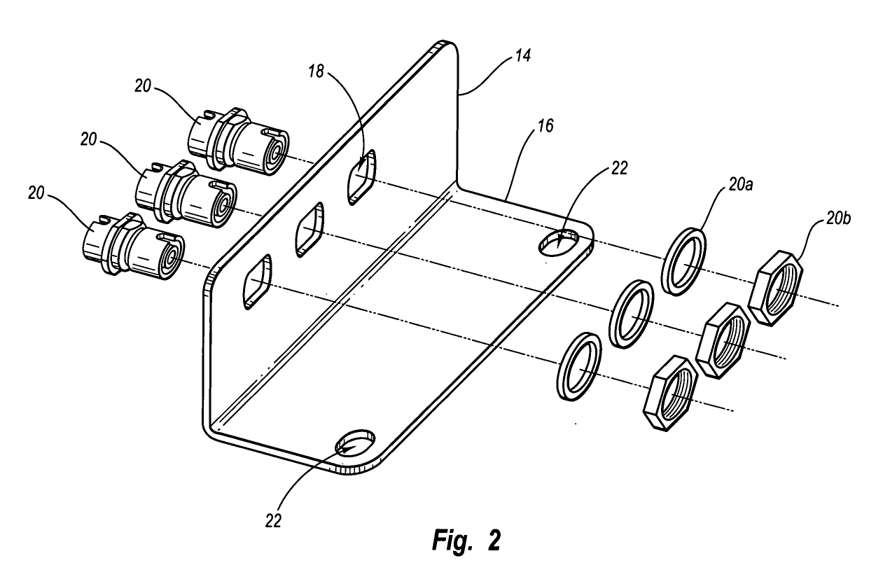

Coupling members 20 are connected to the propping member 14 by inserting the coupling member through a respective aperture 18 and otherwise securing the coupling member to the propping member. As shown in FIG. 2, connecting means may include washer 20a and nut 20b assembly. Connecting means may include other configurations that may be specific to the particular type of coupling member. For example, some coupling members may require set screws to radially lock the coupling member to the aperture 18. Alternatively, no fastening means may be required. For example, a coupling member may be able to be press-fit into aperture 18 and remain securely disposed therein. Propping member 14 may accommodate coupling members 20 of various sizes and configurations by varying the size of apertures 18.

The connector member 16 is attached to the propping member 14 and is configured to couple the bracket to the base 13. In one embodiment, connector member 16 is a plate disposed at an angle to propping member 14. In another embodiment, connector member 16 may include a pair of feet disposed at an angle to propping member 14. For example, propping member 14 and connector member 16 can be disposed perpendicular to each other. In addition, propping member 14 and connector member 16 can be placed at various angles with respect to each other. For example, a more acute angle (less than 90 degrees) may provide the operator with easier access to the propping member 14. In another embodiment, propping member 14 and connector member 16 can be hingedly or pivotably connected. In addition, means may be provided for fixing the propping member 14 and connector member 16 in a fixed position after selectively adjusting the propping member and connector member in relation to each other.

Connector member 16 can include one or more mounting apertures 22 for mounting to base 13. Bracket 12 can be mounted to base 13 using securing means (not shown) such as screws or other fasteners in conjunction with mounting apertures 22. Other means may be provided for mounting bracket 12 to base 13.

The bracket 12 can be constructed of materials such as metal, plastic, or a combination of these materials. The propping member 14 can be formed integrally with the connector member 16 using welding or adhesive. Alternatively, the propping member 14 can be adjustable with respect to the connector member 16 using a pivoting means such as a hinge. The propping member 14 and connector member 16 may be coupled to each other using other attachment means understood by those of skill in the art in light of this disclosure.

In one embodiment, coupling member 20 are couplings or mating sleeves which are configured to mount pairs of fiber optic cables (not shown). For example, one segment of a fiber optic cable could be mounted to one side of a coupling while the other segment of the same fiber optic cable could be mounted to the opposing side of the coupling on the other side of the propping member. In this manner, using the fiber optic mounting system 10, an operator or technician during development or assembly of a fiber optic component can organize the fiber optic cables in order to keep corresponding segments together and also to prevent fiber optic cables from becoming entangled.

In another embodiment, coupling member 20 are connectors, such as FC, ST or other types of connectors. Thus, during development or assembly of a fiber optic component (e.g., free space beam setups), the plurality of coupling members can be used to connect segments of fiber optic cables to hold the fiber optic cables until assembly. It will be appreciated that the plurality of coupling member 20 may have different connectors so that various fiber optic cables having different connectors can be mounted thereto.

The fiber optic mounting system 10 thus provides a means for managing the potential tangling of fiber optic cables in an organized fashion. The fiber optic mounting system 10 can be used in any laboratory, production, or other assembly-type setting. The operator may place labels or other identifying indicia on propping member 14 to assist the operator in organizing the fiber optic cables. Because the fiber optic mounting system 10 prevents the multiple fiber optic cables from becoming entangled, it also assists to prevent the fiber optic cables or connecting components from possible breakage. This helps to reduce the assembly time and reduce the cost of assembling fiber optic components.

The bracket 12 can be disposed on the base 13 in various ways so long as the propping member 14 is accessible by the operator to work with coupling members 20. For example, in one embodiment the base 13 is a table having a table top. The connector member 16 can be coupled to the top, side or bottom of the table top while still allowing propping member 14 to be accessible.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A bracket configured to organize a plurality of fiber optic cables, the bracket comprising:
a propping member having at least one aperture formed therein;
at least one coupling member disposed in the at least one aperture, the at least one coupling member configured to selectively couple to an end of a fiber optic cable; and
a connector member connected to the propping member.

2. The bracket as recited in claim 1, wherein the propping member is a plate.

3. The bracket as recited in claim 1, wherein the connector member is a plate.

4. The bracket as recited in claim 1, wherein the coupling member comprises a coupling.

5. The bracket as recited in claim 1, wherein the coupling member comprises a connector.

6. The bracket as recited in claim 5, wherein the coupling member comprises an FC or ST connector.

7. The bracket as recited in claim 1, wherein the propping member and connector member comprise metal or plastic, or a combination thereof.

8. The bracket as recited in claim 1, wherein the connector member comprises apertures configured to be coupled to a base.

9. The bracket as recited in claim 1, wherein the propping member and the connector member are disposed at an angle in relation to each other.

10. The bracket as recited in claim 9, wherein the propping member and connector member are disposed at an orthogonal angle.

11. The bracket as recited in claim 9, wherein the propping member and connector member are rigidly attached.

12. A mounting system configured to organize a plurality of fiber optic cables, the mounting system comprising:
a base; and
a bracket configured to be coupled to the base, the bracket comprising:
a propping member having at least one aperture formed therein;
at least one coupling member disposed in the at least one aperture, the at least one coupling member configured to selectively couple to an end of a fiber optic cable; and
a connector member connected to the propping member, the connector member configured to be couple to the base.

13. The mounting system as recited in claim 12, wherein the propping member is a plate.

14. The mounting system as recited in claim 12, wherein the connector member is a plate.

15. The mounting system as recited in claim 12, wherein the coupling member comprises a coupling.

16. The mounting system as recited in claim 12, wherein the coupling member comprises a connector.

17. The mounting system as recited in claim 16, wherein the coupling member comprises an FC or ST connector.

18. The mounting system as recited in claim 12, wherein the propping member and connector member comprise metal or plastic, or a combination thereof.

19. The mounting system as recited in claim 12, wherein the propping member and the connector member are disposed at an angle in relation to each other.

20. The mounting system as recited in claim 19, wherein the propping member and connector member are disposed at an orthogonal angle.

21. The mounting system as recited in claim 19, wherein the propping member and the connector member are rigidly attached.

22. The mounting system bracket as recited in claim 12, wherein the connector member comprises apertures for coupling the connector member to the base.
